(19) United States
(12) Patent Application Publication
(10) Pub. No.: US 2011/0232296 A1
(43) Pub. Date: Sep. 29, 2011

(54) OPTICAL FUEL NOZZLE FLASHBACK DETECTOR

(75) Inventor: Garth Curtis Frederick, Greenville, SC (US)

(73) Assignee: GENERAL ELECTRIC COMPANY, Schenectady, NY (US)

(21) Appl. No.: 12/730,282

(22) Filed: Mar. 24, 2010

(51) Int. Cl. F02C 7/22; F23N 5/08

(52) U.S. Cl. 60/776; 60/746; 60/737; 250/554

(57) ABSTRACT

According to one aspect of the invention, a combustor is disclosed. The combustor can include a combustor housing, a plurality of nozzles disposed within the combustor housing, and a flame detector disposed on and in optical communication with each of the plurality of fuel nozzles, wherein each flame detector is configured to detect an optical property related to at least one of a flame holding condition and a flashback condition in a respective fuel nozzle.

### BACKGROUND OF THE INVENTION

The subject matter disclosed herein relates to gas turbines and more particularly to flame holding and optical flashback detection.

In a gas turbine, fuel is burned with compressed air, produced by a compressor, in one or more combustors having one or more fuel nozzles configured to provide a premixing of fuel and air in a premixing zone located upstream of a burning zone (main combustion zone). Damage can quickly occur to the combustor when flame holding or flashback occurs in its fuel/air premixing passages. During desirable operation of the combustor, the premixed fuel and air combust downstream of the fuel/air premixing passages in the combustion zone. During flame holding or flashback, the fuel and air mixture in the premixing passages combusts. The flashback condition generally occurs when a flame travels upstream from the main burning zone into the premixing zone or in the fuel nozzles, which is not intended to sustain combustion reactions. As a consequence, serious damage may occur to the combustion system, potentially resulting in a catastrophic malfunction of the system and a concomitant substantial financial loss. If the turbine control system is able to detect a flashback event, the fuel could be moved around the combustor and the flame would be pushed back into the combustion chamber before the fuel nozzle could be damaged. The use of ion-sensing detectors and other devices, such as thermocouples and fiber optics, to detect flashback is well known. However, these detectors simply detect the presence of a flame and do not manage the fuel flow within the turbine. It is therefore desirable to provide a combustor with a flame detection system configured to manage the fuel flow within the gas turbine.

### BRIEF DESCRIPTION OF THE INVENTION

According to one aspect of the invention, a combustor is disclosed. The combustor can include a combustor housing, a plurality of nozzles disposed within the combustor housing, and a flame detector disposed on and in optical communication with each of the plurality of fuel nozzles, wherein each flame detector is configured to detect an optical property related to at least one of a flame holding condition and a flashback condition in a respective fuel nozzle.

According to another aspect of the invention, a gas turbine is disclosed. The gas turbine can include a compressor configured to compress air, a combustor in flow communication with the compressor, the combustor being configured to receive compressed air from the compressor assembly and to combust a fuel stream to generate a combustor exit gas stream. The combustor can include a plurality of nozzles disposed within the combustor housing and a flame detector disposed on and in optical communication with each of the plurality of fuel nozzles, wherein each flame detector is configured to detect an optical property related to at least one of a flame holding condition and a flashback condition in a respective fuel nozzle.

According to yet another aspect of the invention, a method of operating a combustor is disclosed. The method can include introducing fuel from a nozzle and air within a premixing device, forming a gaseous pre-mix, combusting the gaseous pre-mix in a combustion chamber, thereby generating a flame and monitoring the nozzle to determine the presence of flame holding within the nozzle.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a diagrammatical illustration of a gas turbine system in accordance with exemplary embodiments.

FIG. 2 is a diagrammatical illustration of a combustor having a premixing device employed in the gas turbine system of FIG. 1 in accordance with exemplary embodiments.

FIG. 3 diagrammatically illustrates a gas turbine in accordance with exemplary embodiments.

FIG. 4 illustrates a side perspective view of a nozzle configuration having exemplary optical detectors.

FIG. 5 illustrates a single exemplary fuel nozzle.

FIG. 6 illustrates a flow chart of a method for operating a combustor in accordance with exemplary embodiments.

The detailed description explains embodiments of the invention, together with advantages and features, by way of example with reference to the drawings.

### DETAILED DESCRIPTION OF THE INVENTION

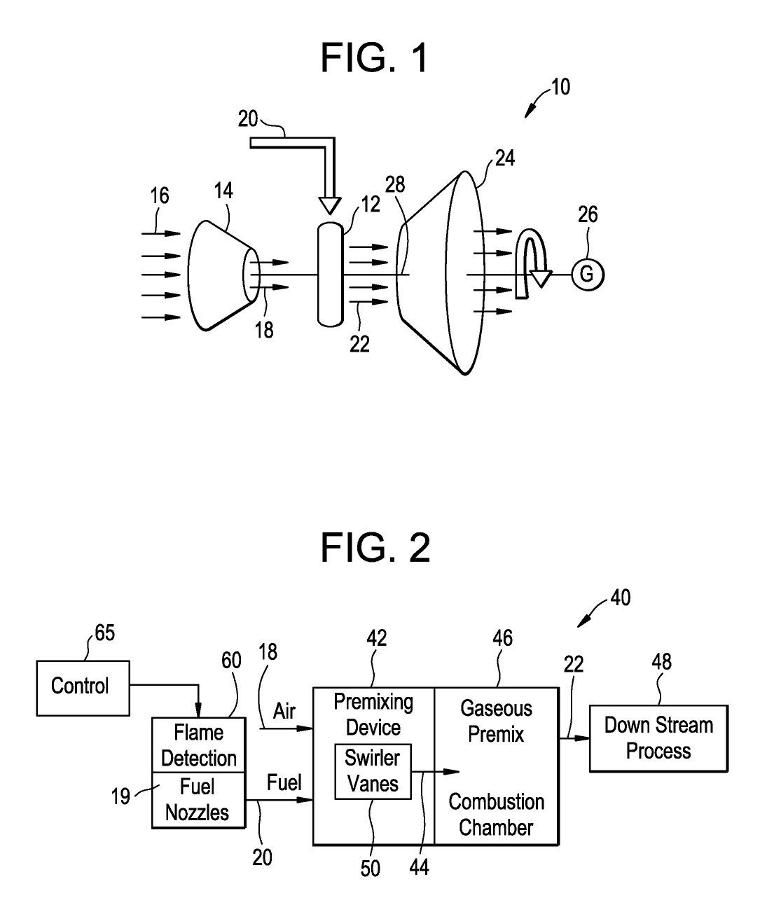

Exemplary embodiments include systems and methods that detect flame holding/flashback in fuel nozzles such as in fuel nozzles employed in gas turbines. In particular, exemplary embodiments include a flame detection system and method configured to detect flame holding/flashback in the fuel nozzles and to take appropriate action to prevent damage to the gas turbine. Turning now to the drawings and referring first to FIG. 1 a gas turbine 10 having a combustor 12 is illustrated. The gas turbine 10 includes a compressor 14 configured to compress ambient air 16. The combustor 12 is in flow communication with the compressor 14 and is configured to receive compressed air 18 from the compressor 14 and to combust a fuel stream 20 to generate a combustor exit gas stream 22. In addition, the gas turbine 10 includes a turbine 24 located downstream of the combustor 12. The turbine 24 is configured to expand the combustor exit gas stream 22 to drive an external load such as a generator 26. In the illustrated embodiment, the compressor 14 is driven by the power generated by the turbine 24 via a shaft 28. The combustor 12 employs a flame detection device configured to detect flame holding/flashback in gas turbine fuel nozzles and to take appropriate action to prevent damage to the gas turbine 10.

FIG. 2 is a diagrammatical illustration of an exemplary configuration 40 having a flame detection device 60 employed in the gas turbine system 10 of FIG. 1 in accordance with exemplary embodiments. As illustrated, the configuration 40 includes the premixing device 42 configured to mix fuel 20 from fuel nozzles 19 and air 18 to form a gaseous pre-mix 44. Further, the configuration 40 includes a combustion chamber 46 configured to combust the pre-mix fuel 44 to form the combustor exit gas stream 22. Further, the combustor exit gas stream 22 is directed to a downstream process 48 such as to the turbine 24 (see FIG. 1) for driving the external load 26 (see FIG. 1). The premixing device 42 can further include a plurality of swirler vanes 50 configured to provide a swirl movement to the fuel 20 and/or air 18 to facilitate mixing of the fuel 20 and air 18.

In exemplary embodiments, the configuration 40 further includes the flame detection device 60, which can be coupled to and in communication with various locations of the configuration 40 such as, but not limited to, the nozzles 19. In exemplary embodiments, as further described herein, the flame detection device 60 is configured to detect flames within the fuel nozzles 19. The configuration 40 can further include a control unit 65 coupled to the flame detection 60. The control unit 65 is configured to receive signals from the flame detection that correspond to detection of flames in the nozzles 19. The control unit 65 is further in communication with the source of the air 18 (e.g., the compressor 14 of FIG. 1) and the fuel 20 (e.g., the nozzles 19). As further described herein, if the control unit 65 receives signals that indicate there is flame holding/flashback in the nozzles 19, the control unit 65 can take appropriate action to mitigate damage to the gas turbine. The appropriate action that the control unit 65 can take includes ceasing fuel and air flow to the combustion chamber or some modification of the air and fuel flow to reduce or eliminate the flame holding/flashback.

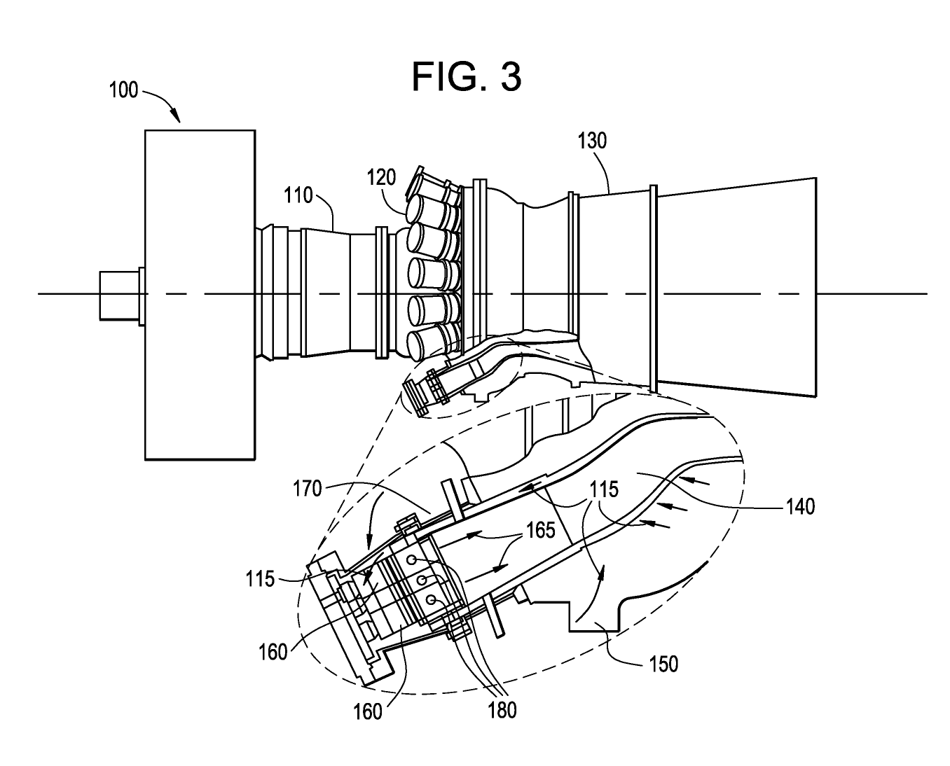

FIG. 3 diagrammatically illustrates an example of a gas turbine 100 including a plurality of flame detectors 180 in accordance with exemplary embodiments. The example of the gas turbine illustrates the flame detectors 180 coupled to and in optical communication with nozzles of the gas turbine 100 and configured to detect the presence of flames within the nozzles 160.

Similar to FIG. 1, the gas turbine 100 includes a compressor 110 configured to compress ambient air. One or more combustor cans 120 are in flow communication with the compressor 110 via a diffuser 150. The combustor cans 120 are configured to receive compressed air 115 from the compressor 110 and to combust a fuel stream from the fuel nozzles 160 to generate a combustor exit gas stream 165 that travels through a combustion chamber 140 to a turbine 130. The turbine 130 is configured to expand the combustor exit gas stream 165 to drive an external load. The combustor cans 120 include an external housing 170, in which the nozzles 160 and flame detectors 180 are disposed.

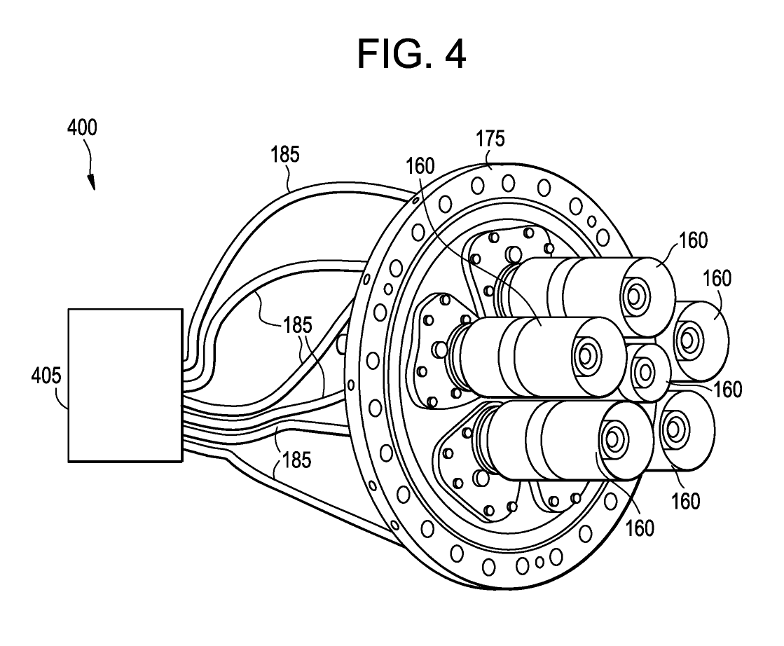

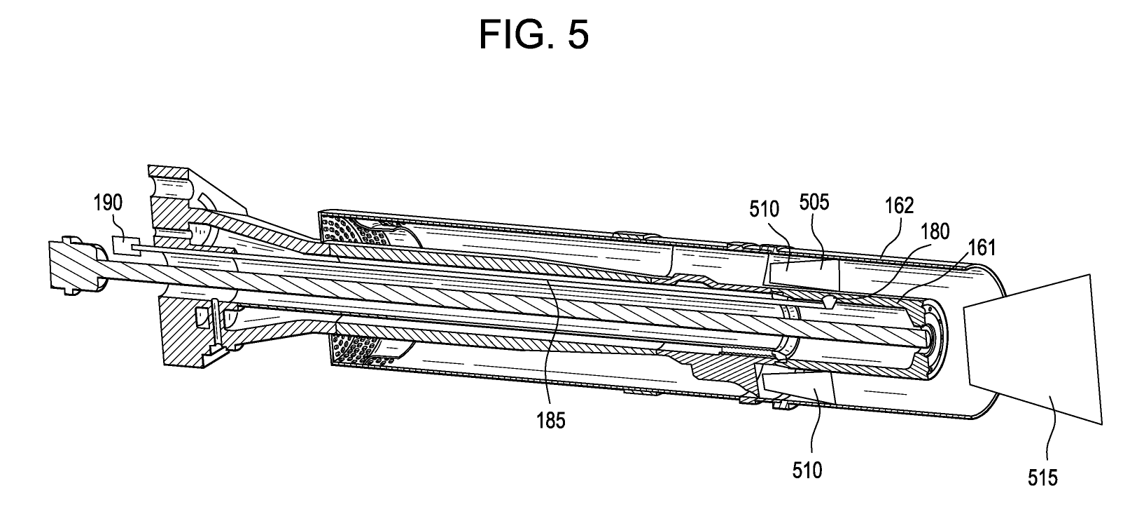

FIG. 4 illustrates a side perspective view of a nozzle configuration 400 having exemplary optical detectors. FIG. 4 illustrates a series of six nozzles 160 shown for illustrative purposes. Fewer or additional nozzles 160 are contemplated in other exemplary embodiments. FIG. 5 illustrates a single exemplary fuel nozzle 160.

The nozzles 160 can be disposed on a nozzle mount 175, which is configured to affix on the external housing for each combustor can 120. Each of the fuel nozzles 160 can include the flame detectors 180. The flame detectors 180 can advantageously be coupled to an inner wall of the fuel nozzles 160. It is appreciated that each of the fuel nozzles 160 includes a respective flame detector 180. The fuel nozzles can further include guides 185, each disposed between the flame detector 180 and the nozzle mount 175. In exemplary embodiments, the guides 185 are disposed along an internal length of each of the fuel nozzles 160. The guides 185 can be disposed along a length adjacent the inner wall. Those skilled in the art understand that the fuel nozzles 160 can include internal passages. In exemplary embodiments, the guides can be disposed in the internal passages and along a length of the fuel nozzle 160, and be breech loaded into the nozzle mount 175. A coupler 190 can be disposed in the nozzle mount 175 and support the guide 185 for coupling to a control unit 405 In exemplary embodiments, the guides 185 are optical guides that are in optical communication with the flame detectors 180. In exemplary embodiments, the guides 185 are breech loaded, and pass through on the nozzle mount 175. In exemplary embodiments, each of the guides 185 is communicatively coupled to the control unit 405.

As such, in exemplary embodiments light paths can be disposed between each of the fuel nozzles and the exterior of the housing 170, via the nozzle mount 175. The light paths can each include the flame detector 180, which can be a lens or window disposed (e.g., via brazing) on each of the fuel nozzles 160. In exemplary embodiments, the flame detector 180 is thus an optical element that is aligned perpendicular to the flow of the fuel within the nozzle 160 in a viewing region 505 disposed between the inner wall 161 and an outer wall 162 of the fuel nozzle 160. The viewing region 505 of the flame detector 180 can be disposed in a region 510 in which flashback or flameholding can occur as opposed to a desirable region 515 for combustion. As such, the light path is initially arranged perpendicular to the fuel flow. The light path can further include the guides 185 to transmit light generated from a flame in the fuel nozzles 160 via the flame detector 180. In exemplary embodiments, the guide 185 can be a series of mirrors fiber optic cables or tubes that are mirror polished on the interior, and can be coupled to a multiplexed center in the control unit 405. The guide 185 can be any optical device that can transmit the light generated by a flame in the nozzles 160. As described herein the guides 185 can then be directed exterior to the housing 170 to the control unit 405 that is configured to detect the flames as optical signals as well as take corrective action such as controlling the fueling schedule of the machine in order to maintain the flame in the combustion chamber, not in the fuel nozzles 160 that can be damaged. As such, the control unit 405 is configured to receive optical signals and interpret the optical signals to determine if a flame is present in the fuel nozzles 160.

In exemplary embodiments, the flame detectors 180 can also be a material having a spectral response to detect flames at particular wavelengths. As such, with prior knowledge of the types of flames and associated wavelengths of the flames generated in the fuel nozzles, the materials selected for the detectors 180 can have a spectral response at the determined wavelengths. For example, it is well known the spectral response of optical detectors (e.g., photodiodes) is primarily determined by the band gap voltage of the material used in the optical detectors. SiC has a band gap voltage of 3.1 volts and has a spectral response that peaks at about 270 nm and has a wavelength limit if about 400 nm. For example, the flame detector can have a spectral response peak proximate a hydrocarbon flame spectral response peak containing hydrocarbon fuel constituents. As such, SiC detectors can be implemented on the nozzles 160 for detection of flames in the nozzles 160. In exemplary embodiments, the guides 185 can be electrical guides such as wire that are breech loaded to the nozzle mount 175 in communicatively coupled to the control unit 405. In exemplary embodiments, the control unit 405 is configured to receive electrical signals from the guides 185 and to extract the spectral response from the signals to determine if a flame is present in the nozzles 160.

As such, optical measurements for fuel nozzle flashback detection is based on the principle that when the fuel heat release moves upstream into the nozzle 160 a strong light signal is emitted in the burner tube. By placing the flame detector 180 in the nozzle 160, a flame holding event occurring in a nozzle 160 can be detected by the signature of light being detected from the optical access port created by the flame detector 180.

In exemplary embodiments, regardless of the types of signals that the control unit 405 receives, the control unit 405 can detect the signal responses from multiple detectors (e.g., the flame detectors 180) and implement algorithms to determine the type of action taken by the control unit 405 in response to a flame holding/flashback condition. For example, the control unit 405 can monitor all of the flame detectors and for any of the flame detectors 180 in which a flame is detected, the control unit 405 can cut off or reduce the fuel flow to those nozzles 160 in which the flame detectors 180 detected a flame. The control unit 405 could also implement a voting algorithm, which can determine if a flashback condition may exist in the combustor can and not just a single nozzle 160. For example, if five of the six detectors 180 determine that a flashback condition exists in the respective nozzles 160, the control unit 405 can then cut off or reduce the fuel to the combustor can 120 because the particular can may be holding a flame. Similarly, if only one flame detector 180 detects flashback, the control unit 405 can decide to continue the fuel until the flame detectors 180 make another reading. Furthermore, multiple detector elements can reside in an enclosure corresponding to the flame detectors 180. For example, a single flame detector 180 may include multiple lenses disposed around the nozzle 160. The multiple detector elements can be multiplexed in order to aggregate the signals detected in the nozzle 160. In this way, the aggregate signal can be implemented to determine the results of the voting algorithm for a single nozzle 160.

In exemplary embodiments, the algorithms discussed herein can sample periodically at each of the flame detectors 180 to determine if a flame exists in the nozzles. In other exemplary embodiments, the algorithms described herein can also constantly monitor whether or not a flame is detected to take immediate action.

In response to detecting a flame, the control unit 405 can redirect fuel from the premixed circuit in the full or part to another fuel circuit, vented or unused fuel circuit. In this way, the control unit 405 can selectively reduce the fuel or shut off the fuel to the one effected fuel nozzle 160. It is appreciated that the combustor can 120 can experience minimal disruption when the control unit 405 acts upon only a single fuel nozzle 160. As such, the affected fuel nozzle 160 can be serviced during the next scheduled outage.

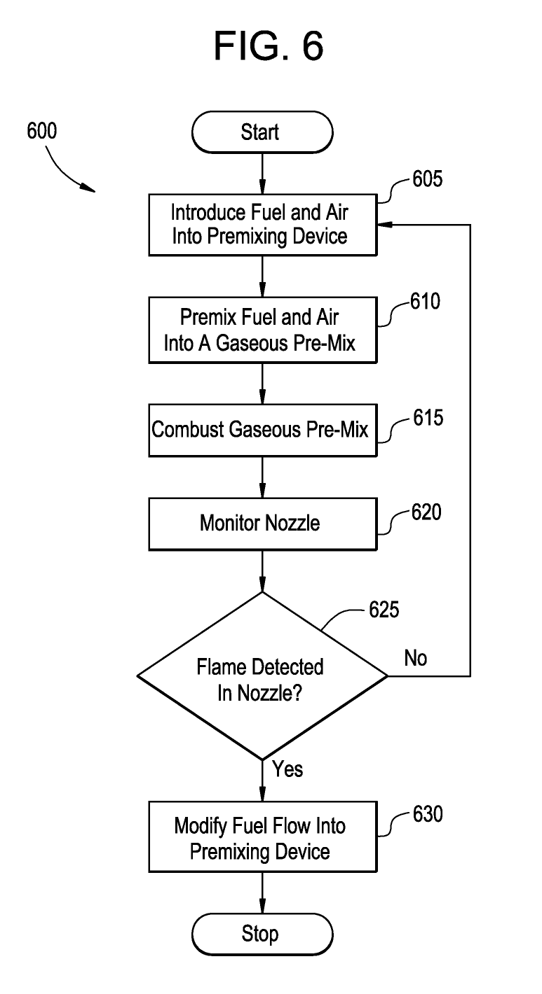

FIG. 6 illustrates a flow chart of a method 600 for operating a combustor in accordance with exemplary embodiments. At block 605, fuel nozzles (e.g., 160 FIG. 3) introduce fuel into a premixing device (e.g., 42 FIG. 2) and a compressor (e.g., 110 FIG. 3) introduces air into the premixing device. At block 610, the premixing device forms a gaseous pre-mix. At block 615, the combustor (e.g., combustor cans 120 FIG. 3) combust the premix in a combustions chamber (e.g., 140 FIG. 3). At block 620, the nozzle is monitored. At block 625, the flame detectors can monitor whether a flame is detected in the nozzle. If the flame detectors detect a flame in the nozzle, then at block 630, the control unit (e.g., control unit 405 in FIG. 4) can modify the fuel flow into the premixing device or other appropriate action described herein. If the flame detectors do not detect a flame at block 625, then the process can continue at block 605. As described herein, the control unit 405 can periodically check for the presence of a flame in the fuel nozzles. Alternatively, the control unit 405 can continuously monitor the fuel nozzles for the presence of a flame.

Technical effects include the ability to run a broader range of fuels in a gas turbine with a decreased concern whether or not flameholding is occurring in the nozzles because any flameholding event is detectable. As such, the flashback detection systems and methods described herein enable an increase in quoting limits for allowable fuel consumption variation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor, comprising:
a combustor housing;
a plurality of nozzles disposed within the combustor housing; and
a flame detector disposed on and in optical communication with each of the plurality of fuel nozzles,
wherein each flame detector is configured to detect an optical property related to at least one of a flame holding condition and a flashback condition in a respective fuel nozzle.

2. The combustor as claimed in claim 1 wherein the optical property is light generated by the at least one of the flame holding condition and the flashback condition.

3. The combustor as claimed in claim 1 further comprising a nozzle mount disposed on the combustor housing and supporting the plurality of nozzles.

4. The combustor as claimed in claim 3 further comprising a guide disposed between each of the flame detectors and the nozzle mount, and breech loaded into the nozzle mount.

5. The combustor as claimed in claim 4 wherein each of flame detectors is in optical communication with a respective fuel nozzle.

6. The combustor as claimed in claim 5 wherein a light path is formed between each of the plurality of fuel nozzles and an external location to the nozzle mount.

7. The combustor as claimed in claim 1 wherein each flame detector includes a spectral response peak proximate a hydrocarbon flame spectral response peak containing hydrocarbon fuel constituents.

8. A gas turbine, comprising:
a compressor configured to compress air;
a combustor in flow communication with the compressor, the combustor being configured to receive compressed air from the compressor assembly and to combust a fuel stream to generate a combustor exit gas stream, the combustor comprising:
a plurality of nozzles disposed within the combustor housing; and
a flame detector disposed on and in optical communication with each of the plurality of fuel nozzles,
wherein each flame detector is configured to detect an optical property related to at least one of a flame holding condition and a flashback condition in a respective fuel nozzle.

9. The gas turbine as claimed in claim 8 wherein the optical property is light generated by the at least one of the flame holding condition and the flashback condition.

10. The gas turbine as claimed in claim 8 further comprising a nozzle mount disposed on the combustor housing and supporting the plurality of nozzles.

11. The gas turbine as claimed in claim 10 further comprising a guide disposed between each of the flame detectors and the nozzle mount, and breech loaded into the nozzle mount.

12. The gas turbine as claimed in claim 11 wherein each of flame detectors is in optical communication with a respective fuel nozzle.

13. The gas turbine as claimed in claim 12 wherein a light path is formed between each of the plurality of fuel nozzles and an external location to the nozzle mount

14. The gas turbine as claimed in claim 8 wherein each flame detector includes a spectral response peak proximate a hydrocarbon flame spectral response peak containing hydrocarbon fuel constituents.

15. A method of operating a combustor, the method comprising:
introducing fuel from a nozzle and air within a premixing device;
forming a gaseous pre-mix;
combusting the gaseous pre-mix in a combustion chamber, thereby generating a flame; and
monitoring the nozzle to determine the presence of flame holding within the nozzle.

16. The method as claimed in claim 15 wherein monitoring the nozzle to determine the presence of flame holding within the nozzle, comprises detecting light as an indication of a flame within the nozzle.

17. The method as claimed in claim 16 further comprising in response to a detection of a flame within the nozzle, modifying the fuel introduced into the nozzle.

18. The method as claimed in claim 17 wherein modifying the fuel introduced into the nozzle comprises ceasing a fuel flow to the nozzle.

19. The method as claimed in claim 16 further comprising in response to a detection of a flame in the nozzle, continuing a supply of fuel to other fuel nozzles disposed adjacent the fuel nozzle.

20. The method as claimed in claim 15 wherein monitoring the nozzle to determine the presence of flame holding within the nozzle, comprises detecting a presence of a spectral peak corresponding to a hydrocarbon flame.
